(19) United States
(12) Patent Application Publication
(10) Pub. No.: US 2009/0042470 A1
(43) Pub. Date: Feb. 12, 2009

(54) QUILTING FABRIC

(76) Inventor: Isamu Tatsuno, Osaka (JP)

Correspondence Address: MORGAN LEWIS & BOCKIUS LLP, 1111 PENNSYLVANIA AVENUE NW, WASHINGTON, DC, 20004, US

(21) Appl. No.: 12/185,247

(22) Filed: Aug. 4, 2008

(30) Foreign Application Priority Data
Aug. 10, 2007 (JP) 2007-208831

(51) Int. Cl. B32B 5/02

(52) U.S. Cl. 442/138

(57) ABSTRACT

Provided is quilting fabric that prevents stitches from affecting extension or contraction of the quilting fabric; prevents misalignment of weave patterns of a front-side fabric and a back-side fabric; and also prevents any part of a filling body placed between the front-side fabric and the back-side fabric from coming out of gaps between the fabric warp yarns and weft yarns.

A quilting fabric 1 has a multilayered structure 40 with stitches 50 made thereon, the multilayered structure 40 including a front-side fabric 10, a back-side fabric 20, and a filling body 30 placed between the front-side fabric 10 and the back-side fabric 20. The stitches 50 on the multilayered structure 40 include: lengthwise stitches 51 arranged in a direction generally parallel to a warp direction of the front-side fabric 10 and the back-side fabric 20; and widthwise stitches 52 arranged in a direction generally parallel to a weft direction of the front-side fabric 10 and the back-side fabric 20.

### CROSS-REFERENCES TO RELATED APPLICATIONS

This application relates to and claims priority from Japanese Patent Application No. 2007-208831, filed on Aug. 10, 2007, the entire disclosure of which is incorporated herein by reference.

### BACKGROUND

1. Field of the Invention

The present invention relates to an improvement of quilting fabric made from stitching (quilting) a multilayered structure including a front-side fabric, a back-side fabric, and a filling body placed between the front-side fabric and the back-side fabric.

2. Description of Related Art

Conventionally, quilting fabric having a three-layered structure has been used, wherein the three-layered structure is made by filling the space between a front-side fabric and a back-side fabric (which are made of cloth, leather, or other material) with a material (filling body) such as cotton, wool, wool yarns, feathers, or urethane foam, and the three-layered structure is then stitched (quilted) decoratively in order to prevent misalignment of the above-described three layers. As this quilting fabric has, for example, superior heat-retaining and body-protecting properties, it is used for various products such as housecoats, futons (such as quilts and down-filled quilts), covers, winter clothes (such as ski wear and coats), bags, babywear, cushions, and house slippers.

As an example of such quilting fabric, there is one obtained by applying dots or a thin film of a synthetic resin binder, that has bonding property when melted, onto both the front and back surfaces of quilt padding made of, for example, polyester cotton formed in a thin layer, placing a quilt top and a quilt backing on both the front and back surfaces of the quilt padding with the synthetic resin binder applied thereon, and heating (for example, by ironing) the three layers of the quilt top, quilt padding, and quit backing so that both the front and back surfaces of the quilt padding are welded with the quilt top and quilt backing via the synthetic resin binder, thereby making basting unnecessary (see, for example, Japanese Utility Model Registration Publication No. 3037449).

However, the conventional quilting fabric mentioned above is stitched (quilted) in a direction(s) oblique to directions of warp yarns and weft yarns forming the front-side fabric and the back-side fabric. The direction oblique to the directions of warp yarns and weft yarns (i.e., a bias direction) is known to be a direction in which the relevant fabric can easily extend or contract.

However, even if the fabric is stitched in that oblique direction, these stitches themselves are not easily extendable or contractible. So, the stitches act to block extension or contraction of the quilting fabric. However, weave patterns of the front-side fabric and the back-side fabric become misaligned and gaps between the fabric warp yarns and weft yarns are enlarged, which makes it easier for the material (such as cotton, wool, wool yarns, or feathers) placed between the front-side fabric and the back-side fabric to come out of the enlarged gaps.

### SUMMARY

The present invention was devised in light of the circumstances described above. It is an object of the invention to provide quilting fabric that prevents stitches from affecting extension or contraction of the quilting fabric, prevents weave patterns of a front-side fabric and a back-side fabric from becoming misaligned, tightened, or broken, and also prevents any part of a filling body placed between the front-side fabric and the back-side fabric from coming out of gaps between the fabric warp yarns and weft yarns.

In order to achieve the above object, provided according to an aspect of the present invention is quilting fabric having a multilayered structure with stitches made thereon, the multilayered structure including a front-side fabric, a back-side fabric, and a filling body placed between the front-side fabric and the back-side fabric, wherein the stitches are arranged in a direction generally parallel to at least one of a warp direction and a weft direction of the front-side fabric and the back-side fabric.

In the quilting fabric having the structure described above, the stitches are arranged in a direction generally parallel to the warp direction of the front-side fabric and the back-side fabric and/or in a direction generally parallel to the weft direction of the front-side fabric and the back-side fabric. Therefore, the stitches can be prevented from affecting extension or contraction of the front-side fabric and the back-side fabric in an oblique direction (bias direction). Also, misalignment of weave patterns of the front-side fabric and the back-side fabric can be prevented.

As an embodiment of the quilting fabric according to the invention, the stitches may be arranged in a generally lattice form, and the stitches may include lengthwise stitches arranged in a direction generally parallel to the warp direction of the front-side fabric and the back-side fabric, and widthwise stitches arranged in a direction generally parallel to the weft direction of the front-side fabric and the back-side fabric.

With the quilting fabric of this invention, the stitches are arranged in a direction generally parallel to at least one of the warp direction and the weft direction of the front-side fabric and the back-side fabric. Therefore, the stitches can be prevented from affecting extension or contraction of the front-side fabric and the back-side fabric in an oblique direction. Accordingly, it is possible to prevent misalignment of the weave patterns of the front-side fabric and the back-side fabric and enlargement of gaps between the fabric warp yarns and weft yarns, and prevent any part of a filling body placed between the front-side fabric and the back-side fabric from coming out of the gaps between the fabric warp yarns and weft yarns.

### BRIEF DESCRIPTION OF THE DRAWINGS

FIG. 1 is an exploded perspective view of quilting fabric according to an embodiment of the invention before the quilting fabric is stitched.

FIG. 2 is a plan view of the quilting fabric according to the embodiment of the invention.

FIG. 3 is a plan view of a conventional quilting fabric.

### DETAILED DESCRIPTION OF PREFERRED EMBODIMENTS

A quilting fabric according to a preferred embodiment of this invention will be described below in detail with reference to the attached drawings. The embodiment described below is for the purpose of describing this invention, but the invention is not limited only to this embodiment. Accordingly, this invention can be utilized in various ways unless the utilizations depart from the gist of the invention.

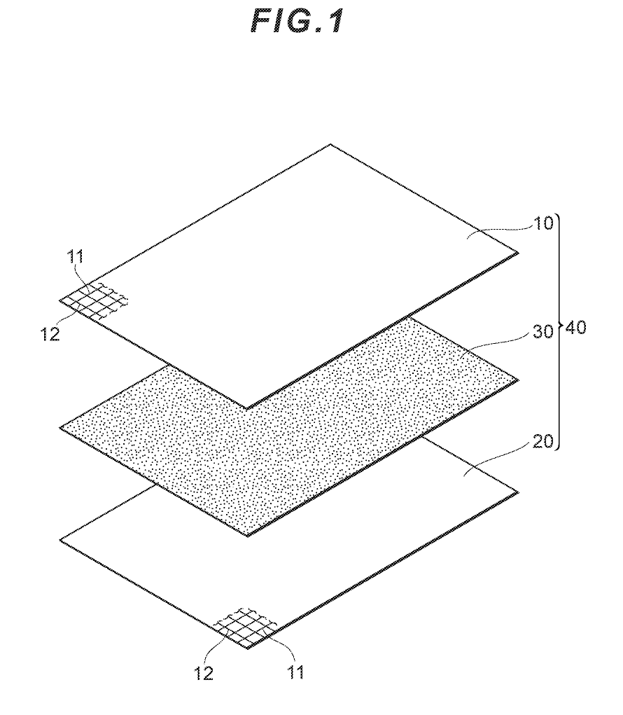

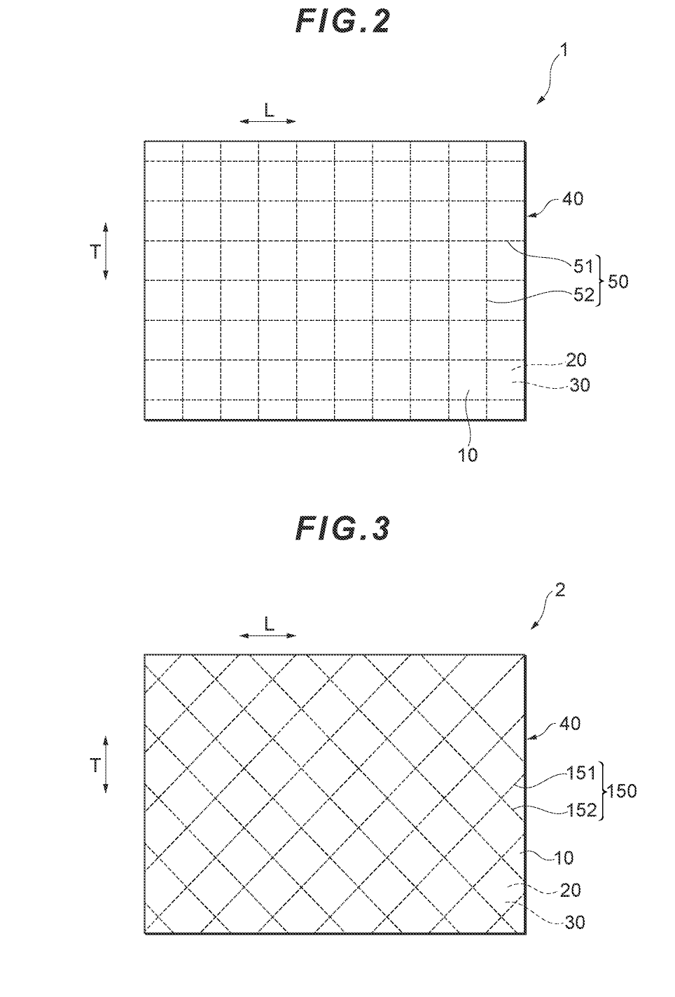

FIG. 1 is an exploded perspective view of quilting fabric according to an embodiment of the invention before the quilting fabric is stitched. FIG. 2 is a plan view of the quilting fabric according to the embodiment of the invention. Each of the above drawings illustrates the thickness, size, enlargement and reduction ratios, and other details of each component; but for ease of comprehension, they are not to scale.

As shown in FIGS. 1 and 2, quilting fabric 1 according to this embodiment is configured so that stitches 50 are made on a three-layered structure 40 obtained by laying a front-side fabric 10, a back-side fabric 20, and a filling body 30 on top of one another (with the filling body 30 held between the front-side fabric 10 and the back-side fabric 20).

The front-side fabric 10 and the back-side fabric 20 are made of a fabric obtained by combining and weaving warp yarns 11 and weft yarns 12. The filling body 30 can be selected from among various materials used for batting for quilting fabric, such as cotton, polyester cotton, wool, felt, wool yarns, and feathers.

The stitches 50 are made to pierce through the three-layered structure 40 in a direction perpendicular to the surfaces of the three layers. The stitches 50 are composed of: a plurality of lengthwise stitches 51 arranged generally in parallel with the direction of the warp yarns 11 (the direction indicated with arrow L in FIG. 2); and widthwise stitches 52 arranged generally in parallel with the direction of the weft yarns 12 (the direction indicated with arrow T in FIG. 2).

Since the stitches 50 in the quilting fabric 1 has the above-described structure with the lengthwise stitches 51 arranged in a direction generally parallel to the warp direction of the front-side fabric 10 and the back-side fabric 20 and the widthwise stitches 52 arranged in a direction generally parallel to the weft direction of the front-side fabric 10 and the back-side fabric 20, the stitches 50 can be prevented from affecting extension or contraction of the front-side fabric 10 and the back-side fabric 20 in an oblique direction (bias direction). Accordingly, it is possible to prevent misalignment of weave patterns of the front-side fabric 10 and the back-side fabric 20 and enlargement of gaps between the fabric warp yarns 11 and weft yarns 12, and prevent any part of the filling body 30 from coming out of the gaps between the fabric warp yarns 11 and weft yarns 12.

On the other hand, stitches 150 in conventional quilting fabric 2 shown in FIG. 3 are composed of first stitches 151 and second stitches 152 arranged in directions oblique to the warp yarn 11 direction (the direction indicated with arrow L in FIG. 3) and the weft yarn 12 direction (the direction indicated with arrow T in FIG. 3) (bias directions—for example, as shown in FIG. 3, directions inclined at approximately 45 degrees with respect to the warp yarns 11 direction and the weft yarns 12 direction). As explained earlier, such oblique directions are the directions in which the fabric can extend or contract more easily than in the warp yarn 11 direction or the weft yarn 12 direction; and it is almost impossible to block extension or contraction in such oblique directions. However, the stitches 150 arranged in the oblique directions cannot be made easily extendable or contractible. Therefore, the stitches 150 block extension or contraction of the quilting fabric 2 in an oblique direction. As a result, there is a possibility that weave patterns of the front-side fabric 10 and the back-side fabric 20 may become misaligned, gaps between the fabric warp yarns 11 and weft yarns 12 may be enlarged, and any part of the filling body 30 may easily come out of the enlarged gaps. Even if the stitches 150 are made using an extendable/contractible thread so that they follow extension or contraction of the quilting fabric 2, there is the possibility that the yarns constituting the weave pattern structure of the quilting fabric 2 may become misaligned and the gaps between the fabric warp yarns 11 and weft yarns 12 may be enlarged, and any part of the filling body 30 may easily come out of the enlarged gaps.

This embodiment has described the case where the quilting fabric 1 has a three-layered structure including the front-side fabric 10, the back-side fabric 20, and the filling body 30 placed between the front-side fabric 10 and the back-side fabric 20. However, the invention is not limited to this example, and a multilayered structure made by placing a layered body, in which a plurality of fine fibrous bodies 30 are laid on top of each other, between the front-side fabric 10 and the back-side fabric 20 may be utilized.

Also, this embodiment has described the stitches 50 arranged in a generally lattice form in which the lengthwise stitches 51 intersect with the widthwise stitches 52 generally perpendicularly to each other. However, the invention is not limited to this example, the stitches 50 may be either a plurality of lengthwise stitches 51 arranged generally parallel to each other or a plurality of widthwise stitches 52 arranged generally parallel to each other, decided as desired. Furthermore, the distances between the parallel lengthwise stitches 51 and between the parallel widthwise stitches 52 may be set as desired.

What is claimed is:

1. Quilting fabric having a multilayered structure with stitches made thereon, the multilayered structure including a front-side fabric, a back-side fabric, and a filling body placed between the front-side fabric and the back-side fabric,
wherein the stitches are arranged in a direction generally parallel to at least one of a warp direction and a weft direction of the front-side fabric and the back-side fabric.

2. The quilting fabric according to claim 1, wherein the stitches are arranged in a generally lattice form, and the stitches include lengthwise stitches arranged in a direction generally parallel to the warp direction of the front-side fabric and the back-side fabric, and widthwise stitches arranged in a direction generally parallel to the weft direction of the front-side fabric and the back-side fabric.
